(19) United States
(12) Patent Application Publication
(10) Pub. No.: US 2008/0177625 A1
(43) Pub. Date: Jul. 24, 2008

(54) INTERNET-BASED SALES SYSTEM AND METHOD INCORPORATING A LOTTERY

(76) Inventor: Lotfi Mehdian, Beverly Hills, CA (US)

Correspondence Address: MARC E. HANKIN, ESQ., 11414 THURSTON CIRCLE, LOS ANGELES, CA, 90049, US

(21) Appl. No.: 11/624,451

(22) Filed: Jan. 18, 2007

(51) Int. Cl. G06Q 30/00

(52) U.S. Cl. 705/14; 705/27

(57) ABSTRACT

Various embodiments of the invention are directed towards an Internet-based system and business method for conducting a lottery in order to sell products, goods, and services over the Internet. In various embodiments of the invention, consumers access a web site that allows them to submit an ante amount in order to enter a lottery for a given product, commodity, or service. Winners of the lottery are randomly selected by the system and method and awarded their chosen product, commodity, or service at a fraction of the retail cost.

### FIELD OF INVENTION

Various embodiments of this invention relate, generally, to Internet-based sales systems and methods, more particularly, to Internet-based sales systems and methods that incorporate a lottery in order to sell products, goods, and services.

### BACKGROUND

Internet-based sales systems have been developed in order that consumers may purchase products, goods, and services by interfacing with Internet-based merchants. The Internet-based merchants benefit by reaching a broader clientele without the need for traditional brick-and-mortar store locations. The consumers, meanwhile, benefit by increased selection, reduced costs, and the ability to conveniently shop, simply by accessing a computer or computerized Internet appliance.

Standard Internet-based merchants allow a consumer to browse among a selection of products, goods, and services and select one or more products or services according to the price that they are offered by the various merchants. Like conventional storefronts, in these standard Internet-based shopping systems, the price of goods is fixed and selected by the merchant.

Other Internet-based sales systems utilize an auction in order to sell the merchant's goods or the goods of third parties. In these auction type systems, the price of goods is not fixed, but rather determined by the highest amount that a purchaser is willing to offer. Such auction systems also facilitate the consignment of goods by third party dealers.

None of these Internet-based systems, however, allow users to enter a lottery as a means for purchasing goods and services.

Meanwhile, Internet-based systems have also been developed in order to allow gambling. Common casino games, such as poker, blackjack, slots, and other such games are presented for playing over the Internet and with winnings paid electronically to the player's account. These systems, however, are not directed towards selling goods and services to users. These systems are limited to collecting bets from game players and rewarding winners with cash prizes.

While these systems offer opportunities to purchase goods and gamble over the Internet, they fail to disclose a system whereby consumers may selectively enter lotteries in order to purchase particular goods and services. They also fail to disclose methods whereby Internet-based merchants may use lotteries as a method to sell and market goods. Thus, there remains a long felt need in the art for an Internet-based system and method that allows consumers to selectively enter a lottery wherein the winner receives selected products, goods, and services.

### DESCRIPTION OF THE INVENTION

In the following description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the description is to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “lottery” refers to any of various random selections or games of chance that can be used to select one or more winners; “goods” or “product” refers to any of the various new or used goods, products, commodities, or services that are commonly sold or exchanged by persons or businesses; and “computer” refers to any device that processes information with an integrated circuit chip, including without limitation, mainframe computers, work stations, servers, desktop computers, portable computers, embedded computers, wireless devices such as cellular phones, personal digital assistants, portable game players, and hand-held computers; “Internet” refers to any collection of networks using standard protocols; and “web site” refers to any document written in a mark-up language including, but not limited to, HTML (hypertext mark-up language) or VRML (virtual reality modeling language), dynamic HTML, XML (extended mark-up language), WML, or related computer languages thereof, as well as to any collection of such documents reachable through one specific Internet address or at one specific World Wide Web site, or any document obtainable through a particular URL (Uniform Resource Locator).

Various embodiments of the invention are directed towards overcoming the above shortcomings by disclosing an Internet-based system for conducting a lottery in order to sell products, goods, and services.

Various embodiments of the invention comprise an Internet-based system and method that allows a plurality of consumers to visit a web site and select among one or more goods offered for sale. Rather than purchasing the goods for a fixed price (as disclosed by conventional Internet-based shopping methods) or purchasing goods on the condition that the consumer is the highest bidder (as disclosed by the auction-based shopping systems), various embodiments of the invention allow a consumer to purchase goods by entering into a lottery for the goods.

For example, in various embodiments of the invention, a plurality of consumers visit a web site operated according to the principles of the invention, and a given consumer then selects a particular product or service that that customer desires. Then, rather than purchasing a product for the cost of the product, that customer pays an ante, which is a fractional amount of the product cost in order to enter a lottery for the award of the product or service.

Upon submission of a pre-determined minimum number of lottery entries, the system selects a winner of the lottery through a random selection process. The pre-determined minimum number of required lottery entries is determined by calculating the cost of the commodity plus a sellers' premium, in order to allow for overhead and profit for operating the system. For example, for the sale of a $10,000 car, the service may require a minimum of 11,000 entries at $1 per entry, in order to total $11,000. In this manner, $10,000 is allowed for the cost of the car and $1,000 is allowed for the service's overhead and profit. In this manner, the minimum number of lottery entries ensures that the service is compensated and makes a profit on each sale.

In other embodiments of the invention, a pre-determined time (rather than a pre-determined number of entries) is used as a cut-off point for receiving entries to the lottery.

In various embodiments of the invention, a product sale may also feature a maximum number of entries. For consumers, a low maximum number of entries is desirable because it increases the likelihood that they will win in the lottery. For some products, the minimum and maximum number of entries may be the same number. In this manner, the maximum number of entries makes the system more attractive to consumers because it increases the likelihood that they will win a given product.

There are several types of goods and services that may be offered through the system. First, the system and method may be used in order to market and sell products, goods, or services, which are owned by the web site itself. In such cases, the web site operates by buying goods at wholesale or discounted prices and selling them through the system and method.

In other embodiments of the invention, the system and method may be used to sell goods offered for sale by a third-party merchant or third-party Internet merchant. In these embodiments, the web site itself does not keep an inventory of the particular goods or services. Rather, the web site allows users to use the system and method to purchase goods offered by a third-party merchant or third-party Internet merchant. Thus, in this manner, the system and method may be applied as a purchase method for goods and services offered by a variety of merchants.

In yet other embodiments of the invention, the system and method is used in order to market goods placed on consignment. For example, a party that wishes to offer a product for sale may place it on the web site and the web site can offer to sell the product or service to the general public by using the system and method. In this manner, the system and method may also be applied to consignment type sales.

In yet another application of the invention, the system and method may be used in order to offer items for sale that are donated to a charity. In this application, a party that wishes to donate to a charity may offer a product through the system web site in order that the general public may submit lottery entries to compete for the product. Upon closing of the lottery, the winner receives the product, the system web site receives a commission, and the balance is awarded to the charity of the product owner's choice. In this manner, the principles of the invention may also be practiced in order to allow third parties to convert goods into charitable contributions.

It should be noted that, in various embodiments of the invention, the prospective buyer is able to adjust the risk or likelihood of winning a given sale by adjusting the number of entries submitted. For example, if a $100 product is marketed with a lottery costing $1 per ticket, a user may earn a 25% probability of winning the product by purchasing 25 tickets.

The above description describes the principles of the invention in general terms. It should be noted that, in the interests of conciseness, details of the invention that are commonly known in the art are not specifically disclosed. Also, the principles of the invention may be practiced with any of the various computer-based and Internet-based systems currently known in the art for accessing on-line networks. Any reference or non-reference to a particular system, product or service shall not be interpreted to restrict the scope of the invention.

1. An Internet-based system for selling products, goods, and services using a lottery, comprising:
a system for displaying a plurality of products, goods, and services on a web site such that consumers may browse and select among the plurality of products, goods, and services in order to enter a lottery for each product, commodity, or service,
a system that allows a plurality of consumers to enter a lottery for each particular product, commodity or service,
a system for collecting an ante from each consumer that desires to enter a lottery for a particular product, commodity, or service, said ante comprising a fractional amount of the total value of the product, commodity, or service,
a system for determining a time at which the lottery for a particular product, commodity, or service is closed,
a system for randomly selecting one lottery winner among the plurality of consumers that enter a lottery for each particular product, commodity, or service, and
a system for awarding each lottery winner the particular product, commodity or service won in the lottery.

2. An Internet-based system for selling products, goods, and services using a lottery according to claim 1, wherein the merchant of said products, goods, and services operates the Internet-based system for selling products, goods, and services over the Internet.

3. An Internet-based system for selling products, goods, and services using a lottery according to claim 1, wherein the merchant of said products, goods, and services is a third-party that accepts payment from the provider of the Internet-based system for selling products, goods, and services as a payment means for purchasing the merchant's goods.

4. An Internet-based system for selling products, goods, and services using a lottery according to claim 1, wherein the provider of the Internet-based system for selling products, goods, and services operates as a consignor of third-party's products, goods, and services.

5. An Internet-based system for selling products, goods, and services using a lottery according to claim 1, wherein the provider of the Internet-based system for selling products, goods, and services operates as a consignor of products, goods, and services offered as donations to a third-party charity and supplies portions of proceeds from the lottery to said third-party charity.

6. An Internet-based system for selling products, goods, and services using a lottery according to claim 1, wherein the provider of the Internet-based system for selling products, goods, and services further offers said products, goods, and services for sale at their retail cost.

7. An Internet-based system for selling products, goods, and services using a lottery according to claim 1, wherein the losers of said lotteries automatically receive advertisements to purchase the products, goods, or services that they entered to win at their retail cost.

8. An Internet-based system for selling products, goods, and services using a lottery according to claim 1, wherein said system for determining a time at which the lottery for a particular product, commodity, or service is closed comprises a system for determining when a minimum number of entries for the lottery are received.

9. A business method for conducting Internet-based sales of products, goods, and services, comprising:
establishing a web site that is accessible over the Internet, said web site serving as a user interface to an Internet-based system for selling products, goods, and services using a lottery, said Internet-based system for selling products, goods, and services using a lottery, comprising:
a system for displaying a plurality of products, goods, and services on a web site such that consumers may browse and select among the plurality of products, goods, and services in order to enter a lottery for each product, commodity, or service,
a system that allows a plurality of consumers to enter a lottery for each particular product, commodity or service,
a system for collecting an ante from each consumer that desires to enter a lottery for a particular product, commodity, or service, said ante comprising a fractional amount of the total value of the product, commodity, or service,
a system for determining a time at which the lottery for a particular product, commodity, or service is closed,
a system for randomly selecting one lottery winner among the plurality of consumers that enter a lottery for each particular product, commodity, or service, and
a system for awarding each lottery winner the particular product, commodity or service won in the lottery.

10. A business method for conducting Internet-based sales of products, goods, and services according to claim 9, wherein the merchant of said products, goods, and services operates the Internet-based system for selling products, goods, and services over the Internet.

11. A business method for conducting Internet-based sales of products, goods, and services according to claim 9, wherein the merchant of said products, goods, and services is a third-party that accepts payment from the provider of the Internet-based system for selling products, goods, and services as a payment means for purchasing the merchant's goods.

12. A business method for conducting Internet-based sales of products, goods, and services according to claim 9, wherein the provider of the Internet-based system for selling products, goods, and services operates as a consignor of third-party's products, goods, and services.

13. A business method for conducting Internet-based sales of products, goods, and services according to claim 9, wherein the provider of the Internet-based system for selling products, goods, and services operates as a consignor of products, goods, and services offered as donations to a third-party charity and supplies portions of proceeds from the lottery to said third-party charity.

14. A business method for conducting Internet-based sales of products, goods, and services according to claim 9, wherein the provider of the Internet-based system for selling products, goods, and services further offers said products, goods, and services for sale at their retail cost.

15. A business method for conducting Internet-based sales of products, goods, and services according to claim 9, wherein the losers of said lotteries automatically receive advertisements to purchase the products, goods, or services that they entered to win at their retail cost.

16. A business method for conducting Internet-based sales of products, goods, and services according to claim 9, wherein said system for determining a time at which the lottery for a particular product, commodity, or service is closed comprises a system for determining when a minimum number of entries for the lottery are received.

17. A business method for conducting Internet-based sales of products, goods, and services according to claim 9, wherein said system for determining a time at which the lottery for a particular product, commodity, or service is closed comprises a system for determining when the closing time for the lottery has passed.

18. A method for conducting Internet-based sales of products, goods, and services, comprising:
displaying a plurality of products, goods, and services on a web site such that consumers may browse and select among the plurality of products, goods, and services in order to enter a lottery for each product, commodity, or service,
receiving lottery entries from a plurality of consumers to enter a lottery for each particular product, commodity or service,
collecting an ante from each consumer that desires to enter a lottery for a particular product, commodity, or service, said ante comprising a fractional amount of the total value of the product, commodity, or service,
determining a time at which the lottery for a particular product, commodity, or service is closed,
randomly selecting one lottery winner among the plurality of consumers that enter a lottery for each particular product, commodity, or service, and
awarding each lottery winner the particular product, commodity or service won in the lottery.

19. A method for conducting Internet-based sales of products, goods, and services according to claim 18, wherein the merchant of said products, goods, and services operates the Internet-based system for selling products, goods, and services over the Internet.

20. A method for conducting Internet-based sales of products, goods, and services according to claim 18, wherein the merchant of said products, goods, and services is a third-party that accepts payment from the provider of the Internet-based system for selling products, goods, and services as a payment means for purchasing the merchant's goods.

21. A method for conducting Internet-based sales of products, goods, and services according to claim 18, wherein the provider of the Internet-based system for selling products, goods, and services operates as a consignor of third-party's products, goods, and services.

22. A method for conducting Internet-based sales of products, goods, and services according to claim 18, wherein the provider of the Internet-based system for selling products, goods, and services operates as a consignor of products, goods, and services offered as donations to a third-party charity and supplies portions of proceeds from the lottery to said third-party charity.

23. A method for conducting Internet-based sales of products, goods, and services according to claim 18, wherein the provider of the Internet-based system for selling products, goods, and services further offers said products, goods, and services for sale at their retail cost.

24. A method for conducting Internet-based sales of products, goods, and services according to claim 18, wherein the losers of said lotteries automatically receive advertisements to purchase the products, goods, or services that they entered to win at their retail cost.

25. A method for conducting Internet-based sales of products, goods, and services according to claim 18, wherein the method for determining a time at which the lottery for a particular product, commodity, or service is closed comprises determining when a minimum number of entries for the lottery are received.

26. (canceled)
